(19) United States
(12) Patent Application Publication
(10) Pub. No.: US 2014/0137567 A1
(43) Pub. Date: May 22, 2014

(54) MICRO GAS TURBINE HAVING IGNITOR-COUPLING STRUCTURER AND METHOD OF ASSEMBLING THE SAME

(71) Applicant: STX HEAVY INDUSTRIES, CO., LTD., Gyeongsangnam-do (KR)

(72) Inventors: Jung Min PARK, Gyeongsangnam-do (KR); Jae Suk PARK, Daegu (KR); Sang Min LEE, Daegu (KR); Ta Kwan WOO, Busan (KR)

(73) Assignee: STX Heavy Industries, Co., Ltd., Gyeongsangnam-do (KR)

(21) Appl. No.: 13/798,331

(22) Filed: Mar. 13, 2013

(30) Foreign Application Priority Data
Nov. 22, 2012 (KR) 10-2012-0133033

(51) Int. Cl. F02C 7/20; F02C 7/26

(52) U.S. Cl. CPC F02C 7/20; F02C 7/26
USPC 60/796; 29/889.2

(57) ABSTRACT

Disclosed are a micro gas turbine and a method of assembling the same. The micro gas turbine includes an ignitor assembly having an ignitor, along with an ignitor-coupling structure. The ignitor-coupling structure includes a mounting bracket having first and second ends, the first end being coupled to the ignitor and the second end being provided on its outer circumference with an external screw. A coupling member is mounted to a liner casing surrounding a combustor and has, on its inner circumference, an internal screw corresponding to the external screw. A bellows surrounds the mounting bracket.

### BACKGROUND OF THE INVENTION

1. Field of the Invention

The present invention relates, in general, to a micro gas turbine having an ignitor-coupling structure and a method of assembling the same. More particularly, the present invention relates to a micro gas turbine having an ignitor-coupling structure which is capable of holding the airtight sealing between a liner casing and a mounting bracket of an ignitor assembly to prevent the fuel-air mixture from leaking therethrough, thereby avoiding reduction in the operation efficiency, and a method of assembling the same.

2. Description of the Related Art

Recently, unlike centralized large-scale power plants, power systems using dispersal type power source such as fuel cells or micro gas turbines are attracting public attention. Particularly, micro gas turbines have many advantages over reciprocating engines having the same output power, such as lower initial investment costs, smaller size and lighter weight, and simpler structure and therefore lower maintenance costs.

FIG. 1 is a cross-sectional view showing the portion around a combustor assembly of a conventional micro gas turbine.

Referring to FIG. 1, the micro gas turbine includes the combustor 10 which is surrounded by a liner casing 50, an ignitor assembly 20 which is radially provided on one side of the combustor perpendicularly to an axis of the combustor such that a lower portion of a mounting bracket thereof 22 is brought into contact with the outer surface of the liner casing, so as to ignite a fuel-air mixture, and a burner assembly 30 which is axially provided to the combustor so as to spray the fuel-air mixture. Here, the ignitor assembly 20 and the burner assembly 30 are integrally coupled to bellows 40 and 42, respectively.

In such a conventional micro gas turbine, when assembling a housing 5 onto a liner casing 50 surrounding the combustor 10, due to its structure, it is impossible to assemble the housing after the ignitor assembly 20 and the burner assembly 30 have been previously mounted. Thus, the assembly is performed such that the housing 5 is first mounted to the liner casing 50, and then the ignitor assembly 20 and the burner assembly 30 are inserted and mounted.

Thus, upon assembly, the mounting bracket 22 of the ignitor assembly only comes into simple physical contact with the liner casing 50, so that they cannot be airtight. In this case, the fuel-air mixture leaks therethrough, reducing the operation efficiency. To solve this problem, an attempt was made to weld a contact between the liner casing 50 and the mounting bracket 22, but the welding process was complicated and was not easy to perform, and consumed a lot of time.

Accordingly, there are needs for technical development in the structure and assembly method which improve the coupling between the ignitor assembly, the liner casing and an outermost housing to facilitate the assembly and secure the airtight sealing between the ignitor assembly and the liner casing.

### SUMMARY OF THE INVENTION

Accordingly, the present invention has been made keeping in mind the above problems occurring in the related art, and the present invention is intended to propose a micro gas turbine which is capable of holding the airtight sealing between a liner casing and a mounting bracket of an ignitor assembly to prevent the fuel-air mixture from leaking therethrough, thereby avoiding reduction in the operation efficiency, and a method of assembling the same.

In order to achieve the above object, according to one aspect of the present invention, there is provided a micro gas turbine including an ignitor assembly having an ignitor, along with an ignitor-coupling structure, the ignitor-coupling structure including: a mounting bracket having first and second ends, the first end being coupled to the ignitor and the second end being provided on its outer circumference with an external screw; a coupling member mounted to a liner casing surrounding a combustor and having, on its inner circumference, an internal screw corresponding to the external screw; and a bellows surrounding the mounting bracket.

In an embodiment, the coupling member may include a first part inserted into the liner casing, and a second part bent from the first part so as to be placed on the liner casing, wherein the bellows comes into close contact with the second part, and wherein the mounting bracket is provided near the second end with an outer circumferential groove such that a space is defined between the mounting bracket and the coupling member.

In another aspect, the present invention provides a method of assembling a micro gas turbine including an ignitor assembly having an ignitor and a mounting bracket coupled to the ignitor, the mounting bracket having an external screw at one side thereof, a coupling member having an internal screw corresponding to the external screw, a liner casing surrounding a combustor, a bellows, and a housing surrounding the liner casing, the method including the steps of: (a) mounting the coupling member in a radial direction onto the liner casing; (b) welding the ignitor assembly and the bellows together to form a sub assembly body; (c) inserting the sub assembly body of the ignitor assembly and the bellows into the housing and rotating the ignitor assembly to inter-engage the external screw of the mounting bracket and the internal screw of the coupling member; and (d) welding a contact between the bellows and the housing.

According to the present invention, a mounting bracket is provided on its outer circumference with an external screw, and a coupling member is provided on its internal circumference with an internal screw corresponding to the external screw, so that when an ignitor assembly is rotated to inter-screw engage the mounting bracket and the coupling member in the state of the coupling member being mounted to a liner casing, the airtight sealing is held between the liner casing and the mounting bracket, thereby preventing the fuel-air mixture from leaking and also preventing the reduction in the operation efficiency of the micro gas turbine.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a cross-sectional view showing the portion around a combustor of a conventional micro gas turbine; and

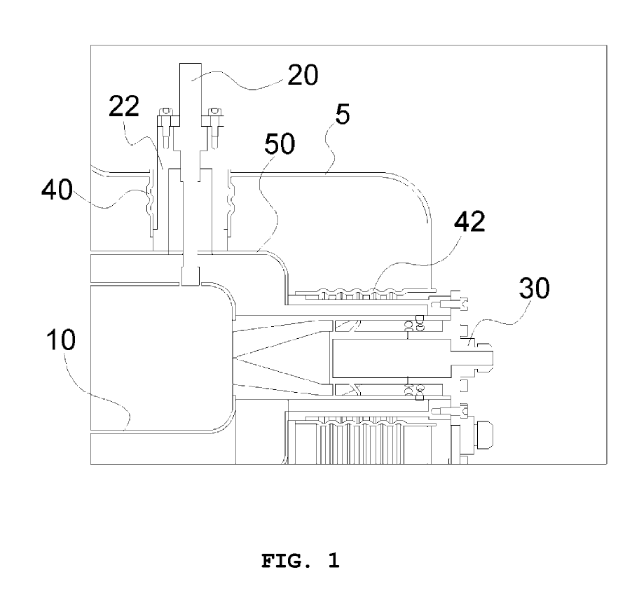

FIG. 2 is a cross-sectional view showing the portion around a combustor of a micro gas turbine having an ignitor-coupling structure according to a preferred embodiment of the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts. In the following description, it is to be noted that, when the functions of conventional elements and the detailed description of elements related with the present invention may make the gist of the present invention unclear, a detailed description of those elements will be omitted. However, it should be understood that the embodiment of the present invention may be changed to a variety of embodiments by those skilled in the art and the scope and spirit of the present invention are not limited to the embodiment described hereinbelow.

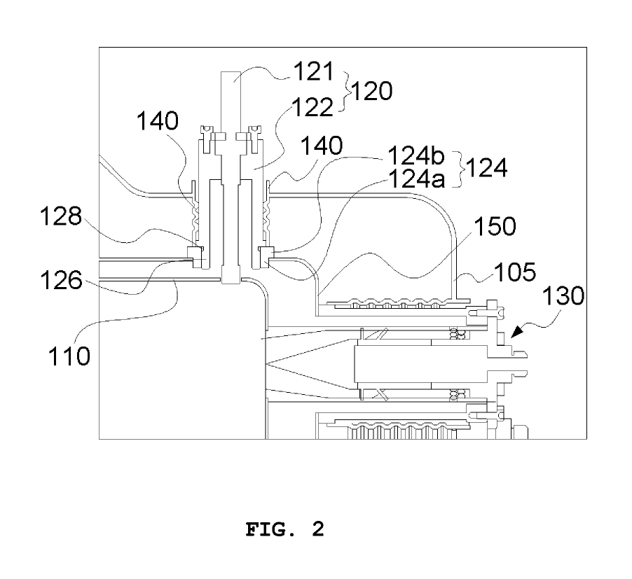

FIG. 2 is a cross-sectional view showing the portion around a combustor of a micro gas turbine having an ignitor-coupling structure according to a preferred embodiment of the present invention.

Referring to FIG. 2, the micro gas turbine having the ignitor-coupling structure includes a housing 105, a combustor 110, an ignitor assembly 120, a coupling member 124, a burner assembly 130, a bellows 140, and a liner casing 150.

The housing 105 covers the liner casing 150 in such a manner that the ignitor assembly 120 and the burner assembly 130 both are partially exposed to the outside.

The ignitor assembly 120 includes an ignitor 121 and a mounting bracket 122.

The ignitor 121 is mounted such that one end thereof is inserted into the combustor 110 and another end thereof is exposed to the outside of the housing 105.

The mounting bracket 122 is configured to hold the ignitor 121 at a first end thereof and to engage the coupling member 124 at a second end thereof. Here, the second end of the mounting bracket 122 is provided on its outer circumference with an external screw 126.

Further, the second end of the mounting bracket 122 is provided with an outer circumferential groove 128 (particularly between a welded portion with the bellows and the external screw 126. The groove 128 defines a space between the mounting bracket 122 and the coupling member 124. The space serves to facilitate the coupling between an upper surface of a second part 124b of the coupling member 124 and the welded portion between the mounting bracket and the bellows and therefore secure a more effective airtight sealing therebetween.

The coupling member 124 is mounted to the liner casing 150. The coupling member 124 is provided on its inner circumference with an internal screw that corresponds to the external screw 126 of the mounting bracket 122.

Specifically, the coupling member 124 includes a first part 124a which is inserted into the liner casing 150, and a second part 124b which is bent from the first part 124a so that it seats over the liner casing 150.

The bellows 140 surrounds the mounting bracket 122 of the ignitor assembly such that it is integrally formed with the mounting bracket 122 by means of e.g. welding.

Next, a method of assembling the micro gas turbine according to the present invention will be described.

First, the housing 105 is mounted over the liner casing 150 (first step).

Next, the coupling member 124 having the internal screw is mounted to the liner casing 150 surrounding the combustor (second step). Here, the coupling member may be mounted by means of e.g. welding.

Next, the bellows 140 is integrally welded onto the ignitor assembly 120 (third step) in which the ignitor 121 is mounted to the mounting bracket 122 having the external screw 126 that corresponds to the internal screw of the coupling member 124. The third step in which the external screw 126 is formed on the outer circumference of the mounting bracket 22, and the ignitor assembly 120 and the bellows 140 are welded together may also be performed before performing the first or second step.

Next, the sub-assembly body of the ignitor assembly 120 and the bellows 140 is inserted into the housing 105, and then the ignitor assembly 120 is rotated to inter-engage the external screw 126 of the mounting bracket 122 and the internal screw of the coupling member 124 (fourth step).

Finally, a contact between the bellows 140 and the housing 105 is welded (fifth step).

When assembled as such using the ignitor-coupling structure, unlike the existing structure in which the lower portion of the mounting bracket of the ignitor assembly comes into simple physical contact with the liner casing, the mounting bracket and the liner casing can together form the airtight sealing therebetween by inter-screw engagement between the mounting bracket and the coupling member. Thereby, the fuel-air mixture is prevented from leaking, avoiding reduction in the operation efficiency of the micro gas turbine.

That is to say, the mounting bracket is screw-coupled with the coupling member at the lower end, and the bellows and the mounting bracket are coupled by means of welding, so that airtight sealing can be maintained as a whole.

Although a preferred embodiment of the present invention has been described for illustrative purposes, those skilled in the art will appreciate that various modifications, additions and substitutions are possible, without departing from the scope and spirit of the invention. Therefore, it should be understood that the disclosed embodiments and figures are merely illustrative forms in all aspects, rather than limited ones, so that the technical scope of the present invention is not limited to the embodiments and figures disclosed. Accordingly, the scope of the present invention should be construed as being defined by following claims and as covering all equivalents of claims.

What is claimed is:

1. A micro gas turbine including an ignitor assembly having an ignitor, along with an ignitor-coupling structure, the ignitor-coupling structure comprising:
a mounting bracket having first and second ends, the first end being coupled to the ignitor and the second end being provided on its outer circumference with an external screw;
a coupling member mounted to a liner casing surrounding a combustor and having, on its inner circumference, an internal screw corresponding to the external screw; and
a bellows surrounding the mounting bracket.

2. The micro gas turbine according to claim 1, the coupling member includes a first part inserted into the liner casing, and a second part bent from the first part so as to be placed on the liner casing, wherein the bellows comes into close contact with the second part, and wherein the mounting bracket is provided near the second end with an outer circumferential groove such that a space is defined between the mounting bracket and the coupling member.

3. A method of assembling a micro gas turbine comprising an ignitor assembly having an ignitor and a mounting bracket coupled to the ignitor, the mounting bracket having an external screw at one side thereof, a coupling member having an internal screw corresponding to the external screw, a liner casing surrounding a combustor, a bellows, and a housing surrounding the liner casing, the method comprising the steps of:
mounting the coupling member in a radial direction onto the liner casing;
welding the ignitor assembly and the bellows together to form a sub assembly body;
inserting the sub assembly body of the ignitor assembly and the bellows into the housing and rotating the ignitor assembly to inter-engage the external screw of the mounting bracket and the internal screw of the coupling member; and
welding a contact between the bellows and the housing.
